(19) United States
(12) Patent Application Publication
(10) Pub. No.: US 2010/0077297 A1
(43) Pub. Date: Mar. 25, 2010

(54) INFORMATION PROCESSING APPARATUS, PROCESSING METHOD THEREFOR, AND COMPUTER-READABLE STORAGE MEDIUM

(75) Inventor: Shinjiro Hori, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/536,802

(22) Filed: Aug. 6, 2009

(30) Foreign Application Priority Data
Sep. 25, 2008 (JP) 2008-246600

(51) Int. Cl. G06F 17/00; G06F 3/048

(52) U.S. Cl. 715/243; 382/106; 715/810

(57) ABSTRACT

An information processing apparatus selects, as layout targets, a plurality of images captured by an image capture apparatus. The information processing apparatus detects a subject or a specific portion of the subject as an object in each of the selected images, and analyzes distance information from the position of the image capture apparatus to the object based on the sizes of the image and object. The information processing apparatus edits the layout positions of the images based on the distance information obtained by the analysis, and lays out the images on a layout screen.

### BACKGROUND OF THE INVENTION

1. Field of the Invention

The present invention relates to an information processing apparatus which edits the layout positions of images and lays them out on a two-dimensional layout screen, a processing method therefor, and a computer-readable storage medium.

2. Description of the Related Art

As a practical use of photographs, they are mounted to create an album. When a user captures images with a digital camera, he can create an album from the digital data. Creation of such an album requires neither development nor mounting. Creating an album from digital data is easier and has higher degree of freedom compared to, for example, creating an album by mounting printed photographic paper.

Unlike a silver halide film, a larger image capture count is implemented by an increasing memory capacity,. Layout work (e.g., selecting a target one of images) takes a long time when creating an album from big stuck of photographs.

To solve this problem, Japanese Patent Laid-Open No. 2006-285964 discloses a layout method using the image capture date. Japanese Patent Laid-Open No. 2006-293986 discloses a method of extracting objects from images and laying out images based on the number of images containing two objects and their relevance. Japanese Patent Laid-Open No. 2006-304265 discloses a method of creating a natural layout based on the directional components of images.

An example of laying out images based on the image capture date, the relevance of captured subjects, or the directional components of images will be explained. For example, when images are laid out in accordance with the image capture date, a layout shown in FIG. 23 is obtained. Six image data items 2301 to 2306 obtained within a predetermined period are laid out on a layout medium (e.g., print paper) 2300. In this example, the image data items 2301 to 2306 are laid out from an upper left portion in order of the image capture date.

Based on the perspective and depth feel of images, the images are classified into

near view image: an image in which a subject seems large because of a short distance to the subject,

distance view image: an image in which a subject seems small because of a long distance to the subject, and

middle view image: an image which is neither a near view image nor distance view image.

Then, the image data items 2302 and 2306 are classified into near view images. The image data items 2301 and 2303 are classified into middle view images. The image data items 2304 and 2305 are classified into distance view images. In the layout of FIG. 23, near view images, middle view images, and distance view images are mixed.

A landscape the user sees in a real space always stretches from a near view to a distance view. The layout screen can produce a pseudo perspective and depth feel by ensuring continuity from a near view to a distance view even in the layout of one page of an album.

Japanese Patent Laid-Open No. 2004-362403 discloses a technique of determining the ratio of a region where images are superposed by using focal length information in header information of image data acquired by a digital still camera.

This technique makes the determination based on header information. For example, when a photograph taken by a silver halide camera is converted into digital data by a scanner or the like, the image data does not have header information itself and no focal length information can be attained. Such image data items cannot be laid out in consideration of perspective and depth feel.

### SUMMARY OF THE INVENTION

The present invention provides an information processing apparatus which analyzes distance information to a subject in accordance with the subject size, edits layout positions based on the analysis result, and lays out images on the layout screen, a processing method therefor, and a computer-readable storage medium.

According to a first aspect of the present invention, there is provided an information processing apparatus which edits layout positions of a plurality of images and lays out the plurality of images on a two-dimensional layout screen, the apparatus comprising: a selection unit configured to select a plurality of images captured by an image capture apparatus as layout targets; an analysis unit configured to detect either of a subject and a specific portion of the subject as an object in each of the plurality of images selected by the selection unit, and analyze distance information from a position of the image capture apparatus to the object based on a size of the image and a size of the object; and a layout unit configured to edit the layout positions of the plurality of images based on the distance information obtained by the analysis performed by the analysis unit, and lay out the plurality of images on the layout screen.

According to a second aspect of the present invention, there is provided a processing method for an information processing apparatus which edits layout positions of a plurality of images and lays out the plurality of images on a two-dimensional layout screen, the method comprising: selecting a plurality of images captured by an image capture apparatus as layout targets; detecting either of a subject and a specific portion of the subject as an object in each of the plurality of images selected in the selecting the plurality of images to analyze distance information from a position of the image capture apparatus to the object based on a size of the image and a size of the object; and editing the layout positions of the plurality of images based on the distance information obtained by the analysis in the detecting either of a subject and a specific portion of the subject to lay out the plurality of images on the layout screen.

According to a third aspect of the present invention, there is provided a computer-readable storage medium storing a computer program, the program causing a computer to function as a selection unit configured to select a plurality of images captured by an image capture apparatus as layout targets, an analysis unit configured to detect either of a subject and a specific portion of the subject as an object in each of the plurality of images selected by the selection unit, and analyze distance information from a position of the image capture apparatus to the object based on a size of the image and a size of the object, and a layout unit configured to edit the layout positions of the plurality of images based on the distance information obtained by the analysis performed by the analysis unit, and lay out the plurality of images on a two-dimensional layout screen.

Further features of the present invention will be apparent from the following description of exemplary embodiments with reference to the attached drawings.

### BRIEF DESCRIPTION OF THE DRAWINGS

FIG. 1 is a block diagram exemplifying the functional arrangement of an information processing apparatus 100 according to the first embodiment of the present invention;

FIG. 2 is a flowchart exemplifying the sequence of the overall operation in the information processing apparatus 100 shown in FIG. 1;

FIG. 3 is a view exemplifying a UI;

FIG. 4 is a flowchart exemplifying the operation of an image data item analysis process in S203 of FIG. 2;

FIG. 5 is a view exemplifying an Exif file structure;

FIG. 6 is a table exemplifying the description contents of main information and “tag” addresses representing descriptions;

FIG. 7 is a table exemplifying the description contents of sub information and “tag” addresses representing descriptions;

FIG. 8 is a table exemplifying Makernote data;

FIG. 9 is a view exemplifying a result of analyzing distance information based on Exif information;

FIG. 10 is a view showing a detection example when a person's face is detected in image data;

FIG. 11 is a view exemplifying a result of analyzing distance information based on a face detection result;

FIG. 12 is a view exemplifying an image layout process;

FIG. 13 is a view exemplifying the image layout process;

FIG. 14 is a view exemplifying the image layout process;

FIG. 15 is a view exemplifying the image layout process;

FIG. 16 is a view showing a concrete example of the image layout shown in FIG. 12;

FIG. 17 is a view showing a concrete example of the image layout shown in FIG. 13;

FIG. 18 is a view showing a concrete example of the image layout;

FIG. 19 is a view showing a concrete example of the image layout;

FIG. 20 is a view exemplifying a result of analyzing distance information;

FIG. 21 is a view showing a concrete example of the image layout;

FIG. 22 is a view showing a concrete example of an image layout according to the second embodiment; and

FIG. 23 is a view for explaining a prior art.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

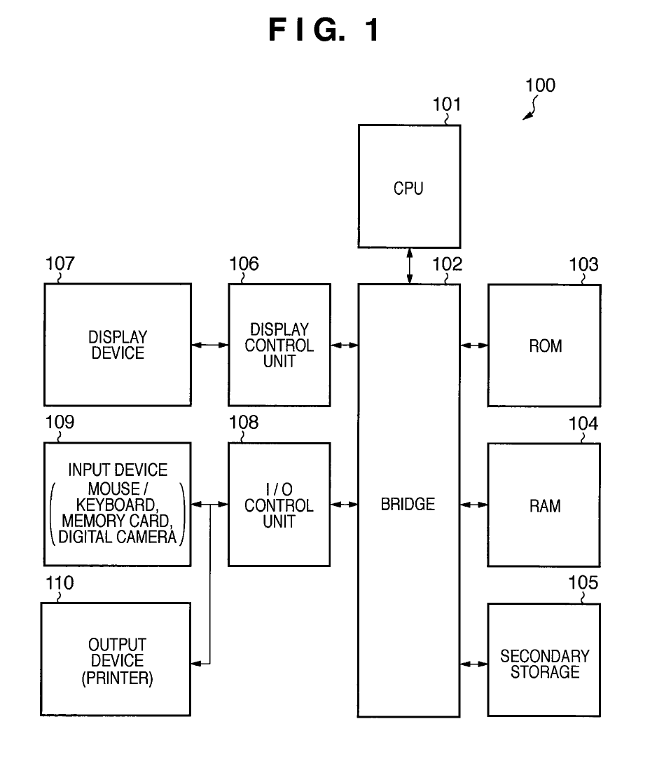

FIG. 1 is a block diagram exemplifying the functional arrangement of an information processing apparatus 100 according to the first embodiment of the present invention.

A CPU (Central Processing Unit) 101 controls other functional blocks and the apparatus. A bridge 102 controls exchange of data between the CPU 101 and other functional blocks.

A ROM (Read Only Memory) 103 is a read-only nonvolatile memory and stores, for example, a program called BIOS (Basic Input/Output System). The BIOS is executed first when the information processing apparatus 100 is activated. The BIOS controls the basic input/output functions of peripheral devices such as a secondary storage 105, display device 107, input device 109, and output device 110.

A RAM (Random Access Memory) 104 is a volatile memory which provides a readable/writable memory area. The secondary storage 105 is an HDD (Hard Disk Drive) which provides a large-capacity memory area. When the BIOS starts running, an OS (Operating System) stored in the HDD is executed. The OS provides basic functions available in all applications, management of an application, and basic GUIs (Graphical User Interfaces). An application combines GUI widget elements provided by the OS to provide a UI which implements application-specific functions. If necessary, the RAM 104 or secondary storage 105 stores the OS, the executing programs of applications, and data used for work.

A display control unit 106 performs control to display various windows on the display device 107. More specifically, the display control unit 106 performs control to generate the result of a user operation to the OS or an application as image data of a GUI and display the image data on the display device 107. The display device 107 is, for example, a liquid crystal display or CRT (Cathode Ray Tube) display.

An I/O control unit 108 provides an interface with the input device 109 and output device 110. The interface is, for example, a USB (Universal Serial Bus) or PS/2 (Personal System/2).

The input device 109 is used to input user operations, various data, and the like to the apparatus. The input device 109 includes a keyboard and mouse. The input device 109 may also include a digital camera or a storage device (e.g., USB memory, CF (Compact Flash) memory, or SD (Secure Digital) memory card) because data (e.g., image data) stored in such a storage device is input to the apparatus. The output device 110 prints on paper or the like in accordance with a variety of data. The output device 110 is, for example, a printer.

The arrangement of the information processing apparatus 100 has been described. Note that the arrangement shown in FIG. 1 is merely an example, and the information processing apparatus 100 is not limited to this. For example, the output device 110 is arranged not as part of the arrangement of the information processing apparatus 100 but as a separate device.

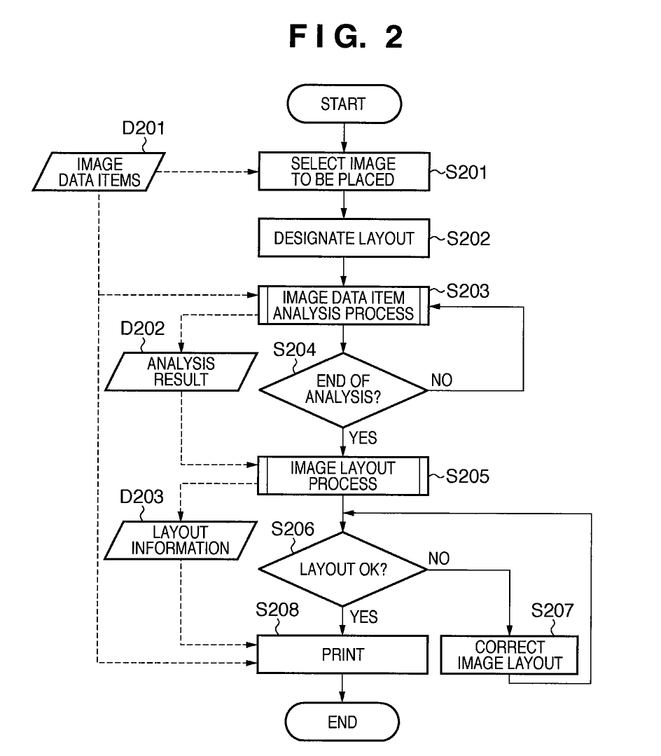

An example of the sequence of the overall operation in the information processing apparatus 100 shown in FIG. 1 will be explained with reference to FIG. 2. The CPU 101 achieves this process by, for example, executing a program stored in the ROM 103 or secondary storage 105. A sequence to create an album from a plurality of image data items and print it will be described. Images to be laid out are image data items D201. The image data items D201 are stored in, for example, the memory area of the secondary storage 105 or a storage (e.g., CF memory or SD memory card) connected to the I/O control unit 108. The image data of the image data items are obtained with an image capture apparatus such as a digital camera and complies with an Exif (Exchangeable image file format) file format (to be described later).

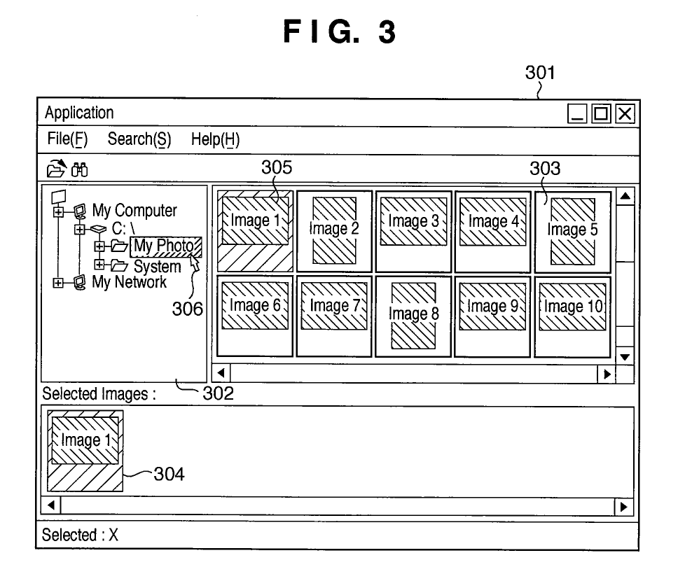

The information processing apparatus 100 selects image data items to be laid out (S201). Image data items are selected based on, for example, a user instruction. More specifically, a user who is to create an album selects images used for image data items of the album from the image data items D201. The user uses, for example, a UI as shown in FIG. 3 to select an image. This UI appears when selecting an image in an album creation application 301. The UI has a display area 302 of a directory tree indicating a location where image data items are saved. The display area 302 displays the arrangement of folders stored in the secondary storage 105. A mouse pointer 306 indicates a position designated with a mouse which is an example of the input device 109. The user manipulates the mouse or keyboard to select image data items. For example, the user designates one folder. The designated folder contains a plurality of image data items, and each image data item is displayed as a thumbnail image in a thumbnail display area 303. The user uses the mouse pointer 306 to select a list of image data items. In response to this operation, the information processing apparatus 100 displays thumbnail images in an area 304. The thumbnail images are layout targets.

After selecting image data items to be laid out, the information processing apparatus 100 designates layout information (S202). This designation is also based on a user instruction similarly to selection of image data items. More specifically, the user inputs an operation to the apparatus to designate the composition of each page of the album. For example, as the layout of one page, the user designates the maximum number of images to be displayed, and the position and size of each image to be pasted. The user may designate all kinds of layout information, or the information processing apparatus may automatically decide them in accordance with the number of selected images or the like.

After designating the layout information (S202), the information processing apparatus 100 analyzes the image data items selected in S201 (S203). In the analysis process, the information processing apparatus 100 derives information representing a distance to a specific subject (e.g., main subject) in the image data item, that is, distance information from the position of the image capture apparatus, which has captured the subject, to the subject. The distance information may be a value representing an actual distance or a quantized value representing the degree of distance. The distance information suffices to be analyzed based on, for example, Exif information, which will be described later.

After analyzing the image data item, the information processing apparatus 100 stores the result as analysis data D202 in the RAM 104 or the like. This process is repetitively executed till the end of analyzing all the image data items selected in S201 (NO in S204). If the analysis of all the image data items ends (YES in S204), the information processing apparatus 100 decides the layout of the images, that is, their layout positions on the layout screen, details of which will be described later (S205). Note that the layout screen corresponds to a photograph mount and is, for example, two-dimensional.

After deciding the layout, the information processing apparatus 100 stores layout information D203 in the RAM 104 or the like to control the layout. The layout information includes at least one of the number of pages of the album, the names of images for use, the save destination, a page number to which each image is pasted, a paste position in a page, and the like. The layout of each page of the album may be created as image data. The storage destination is arbitrarily the secondary storage 105 or RAM 104. The information processing apparatus 100 displays the layout result on the display device 107. The user checks the layout result, and if he is not satisfied with it and inputs an instruction to, for example, execute the process again (NO in S206), the information processing apparatus 100 executes a layout correction process and adjusts the layout again (S207). If the user is satisfied with the layout result, he inputs an instruction representing “OK” (YES in S206). In response to this operation, the information processing apparatus 100 generates print data based on the created layout information, and outputs it to a printer or the like. The printer or the like then prints the album (S208).

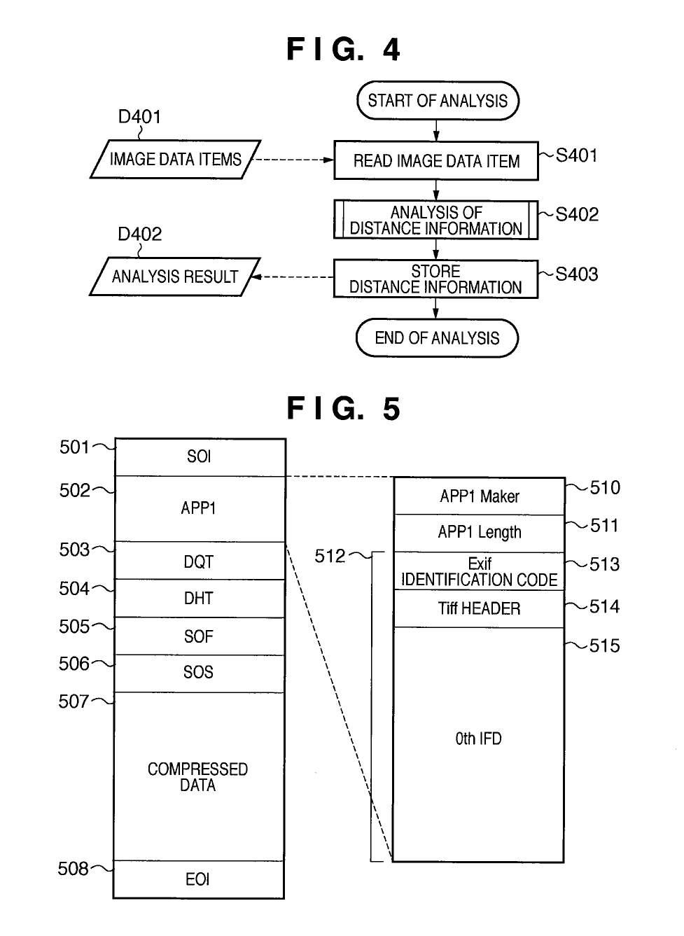

An example of the operation of the image data item analysis process in S203 of FIG. 2 will be explained with reference to FIG. 4. Analysis based on Exif information will be described.

When the process starts, the information processing apparatus 100 reads image data items D401 one by one that have been selected in S201. First, the information processing apparatus 100 reads the first image data item (S401), and analyzes the read image data item (S402). In the analysis process, distance information to a subject in the image data item is analyzed based on Exif information, as described above.

If distance information is obtained as a result of the analysis, the information processing apparatus 100 stores it as an analysis result D402 (S403). The storage destination is arbitrarily the secondary storage 105 or RAM 104. When creating an album again after the album creation application temporarily ends, the analysis result is stored in the secondary storage 105 because the secondary storage 105 keeps holding information without erasing it.

Analysis of distance information in S402 of FIG. 4 will be described. A method of analyzing distance information to a subject in an image data item based on Exif information will be explained. An item of image data obtained by a digital camera is generally saved in the Exif file format. FIG. 5 is a view exemplifying the Exif file format.

The Exif file format is basically the same as a normal JPEG image format. The difference is that thumbnail images, image-capture-related information, and the like are embedded in image data item in conformity to JPEG specifications. An Exif file can be viewed as a normal JPEG image via a JPEG-compliant Internet browser, image viewer, photo retouching software, or the like.

As shown on the left side of FIG. 5, the JPEG file stores an SOI (Start Of Image/0xFFD8) 501 at the beginning. An APP1 502, DQT (Define Quantization Table) 503, DHT (Define Huffman Table) 504, and SOF (Start Of Frame) 505 are stored in order following the SOI 501. An SOS (Start Of Stream) marker 506 and compressed data (data) 507 are also stored sequentially. Finally, an EOI (End Of Image) 508 is stored.

The DQT 503 defines the entity of a quantization table, and the DHT 504 defines the entity of a Huffman table. The SOF 505 indicates the start of a frame, the SOS marker 506 indicates the start of image data, and the EOI 508 indicates the end of the image data. Among markers used in JPEG, markers 0xFFE0 to 0xFFEF are called application markers and are not necessary to decode a JPEG image. These markers are defined as data areas used by respective application programs. The Exif file uses an APP1 (0xFFE1) marker to store image capture conditions and the like in a JPEG image.

The “APP1” structure is shown on the right side of FIG. 5.

“APP1” starts from an APP1 Marker (0xFFE1/2 bytes) area 510. An APP1 Length (2-byte APP1 area size) area 511 and APP1 data area 512 follow the APP1 Marker area 510. The first 6 bytes of the APP1 data area 512 stores an ASCII character string “Exif” functioning as an identifier, and the next 2 bytes hold 0x00. Next to this, data are stored in a Tiff (Tagged image file format) format. The first 8 bytes of the Tiff data provide a Tiff header (Header) area 514. The first 2 bytes of the Tiff header area 514 define a byte order. For example, 0x4d4d:“MM” means a Motorola byte order, and 0x4848:“II” means an Intel byte order.

The first IFD (Image File Directory) is stored in a 0th IFD (IFD of main image) area 515 next to the Tiff header area 514. The first IFD generally contains main image data and image-related data. The description information such as main information, sub information (Exif SubIFD/0x8768), or Makernote information (Makernote/0x827c) changes for each description item.

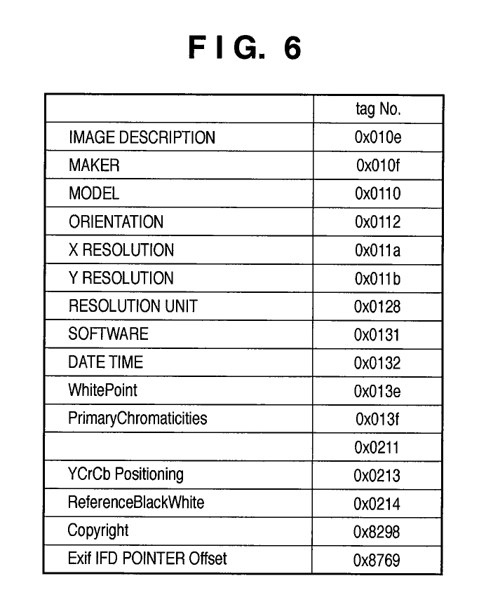

FIG. 6 is a table exemplifying the description contents of the main information and “tag” addresses representing descriptions. The main information describes general information such as the title, the maker name (make) and model of a digital camera, orientation, width (X) resolution, height (Y) resolution, resolution unit, software, and the date and time of change.

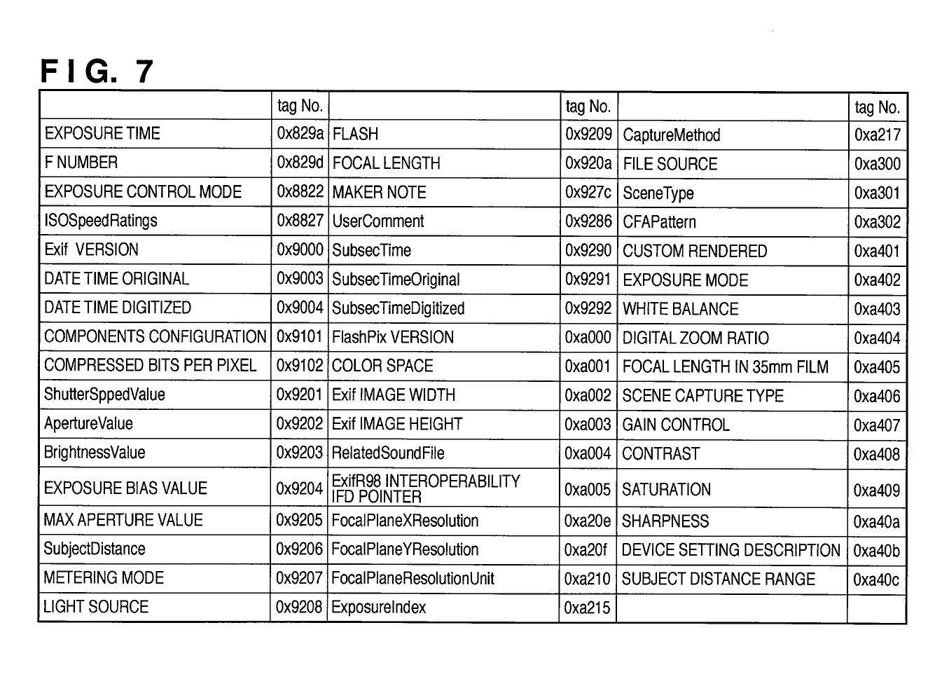

FIG. 7 is a table exemplifying the description contents of the sub information and “tag” addresses representing descriptions. The sub information describes detailed information of a digital camera such as the light source and focal length, and various image capture conditions such as the exposure time, F-number, ISO speed ratings, and metering mode.

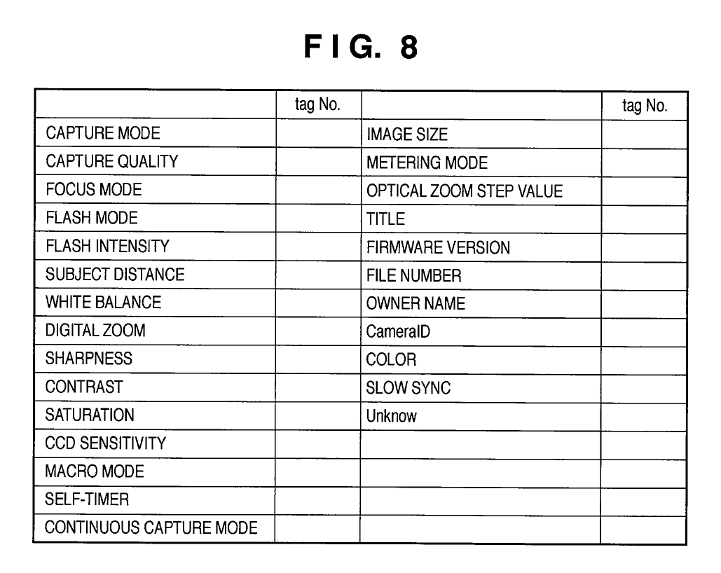

FIG. 8 is a table exemplifying the Makernote data. Description contents, “tag” addresses, and the like in the Makernote data can be freely set by a maker, and details of them are unknown. The Makernote data tends to describe image-capture-related information which is not defined in the sub information. Some Makernote data uniquely describe distance information to a main subject. In this manner, the Exif information contains information capable of analyzing distance information.

For example, in the sub information, the subject distance is SubjectDistance: tag=0x9206, and the subject distance range is SubjectDistanceRange: tag=0xa40c. In the Makernote data, the subject distance is 0xXXXX. The subject distance is expressed by, for example, the numerator and denominator of 32-bit unsigned integers, and the unit is m. A numerator of FFFFFFFFH means infinity, and a numerator of 00000000H means that the distance is unknown.

The subject distance range is expressed by a 16-bit unsigned integer:

0=unknown

1=macro

2=near view

3=distance view

other=reserved

Note that the Makernote data is not stored in a predetermined format.

In addition to these kinds of information, the distance to a subject can also be estimated based on a combination of pieces of information:

SubjectArea: tag=0x9214

FocalLength: tag=0x920a

SubjectLocation: tag=0xa214

FocalLengthIn35 mmFilm: tag=0xa405

SceneCaptureType: tag=0xa406

That is, distance information to a subject is obtained based on at least one of various kinds of information described above.

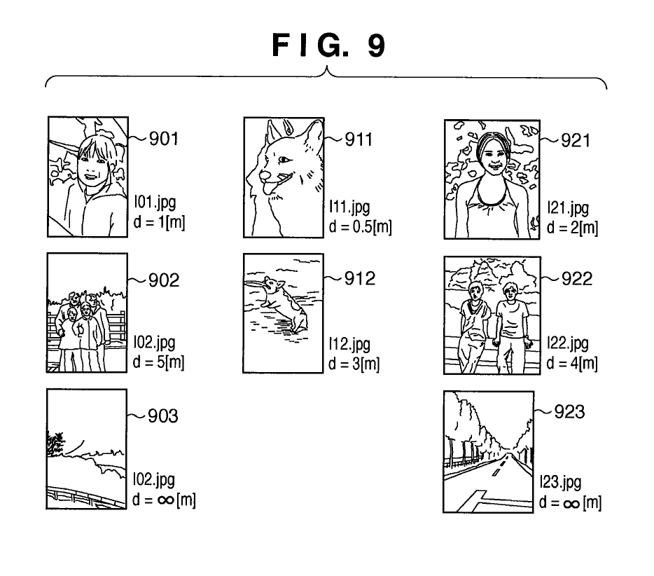

A result of analyzing distance information to a subject (e.g., main subject) based on Exif information will be explained with reference to FIG. 9.

FIG. 9 shows a result of analyzing seven images 901 to 903, 911, 912, and 921 to 923. The analysis result D402 shown in FIG. 4 contains at least a pair of the file name of each image data item and a distance d [m] to a main subject.

It is provisionally defined that the distance d to the main subject=0 (inclusive) to 3 (exclusive) represents a near view, the distance d=3 (inclusive) to 10 (exclusive) represents a middle view, and the distance d=10 (inclusive) or more represents a distance view. From this, it can be determined that the images 901, 911, and 921 are near view images, the images 902, 912, and 922 are middle view images, and the images 903 and 923 are distance view images.

A case in which the image data item analysis process in S203 of FIG. 2 is performed without using Exif information will be explained. This analysis method uses an object of a predetermined size that exists in image data item. If the object exists in image data item, it is detected in the image data item to estimate the distance to the object. The object is, for example, a subject person to be captured or the face (specific portion) of the person. In particular, many detection algorithms have been examined for the face of a person because the applicability of the feature or detection result is very high. Recently, these algorithms implement almost practical performance. Detection of a person's face suffices to employ a technique disclosed in Japanese Patent Laid-Open No. 2002-183731 filed by the present applicant. According to this technique, the eye region is detected from an input image, and a region around the eye region is set as a face candidate area. The luminance gradient of each pixel and the weight of the luminance gradient are calculated for the face candidate region. The calculated luminance gradient and gradient weight are compared with the gradient and gradient weight of an ideal face reference image set in advance. If the average angle between gradients is equal to or smaller than a predetermined threshold, it is determined that the input image contains a face region.

In addition to this technique, a technique disclosed in, for example, Japanese Patent Laid-Open No. 2003-30667 is also available. According to this technique, a skin color region is detected from an image, and the iris color pixels of a man are detected within the skin color region, thereby detecting the positions of the eyes. According to a technique disclosed in Japanese Patent Laid-Open No. 8-63597, the degree of matching between a plurality of face shape templates and an image is calculated. A template exhibiting the highest degree of matching is selected. If the highest degree of matching is equal to or higher than a predetermined threshold, a region in the selected template is set as a face candidate region. The template can be used to detect the positions of the eyes. A technique disclosed in Japanese Patent Laid-Open No. 2000-105829 is also usable. Other methods for detecting a face and organ positions are disclosed in Japanese Patent Laid-Open Nos. 8-77334, 2001-216515, 5-197793, 11-53525, and 2000-132688. Many other methods are also proposed, including Japanese Patent Laid-Open Nos. 2000-235648 and 11-250267 and Japanese Patent No. 2541688. The first embodiment can employ any one of these methods. Detection of a face and organ positions are described in a variety of references and patents, and will not be described here.

An example of the operation of the image data item analysis process in S203 of FIG. 2 will be explained. An analysis using the foregoing face detection technique will be described below. The sequence of the process is the same as that in FIG. 4 described above, and will be explained with reference to FIG. 4.

When the process starts, the information processing apparatus reads image data items D1201 one by one that have been selected in S201. The information processing apparatus reads the first image data item (S401), and analyzes the read image data item (S402). At this time, the information processing apparatus executes a face detection process for the image data item D1201. The information processing apparatus calculates distance information from the face detection result, and stores it as an analysis result D402 (S403). The storage destination is the secondary storage 105 or RAM 104.

FIG. 10 shows a detection example when a person's face is detected in an image data item. Reference numeral 1001 denotes image data. Data obtained by a digital camera is generally defined by a coordinate system in which the abscissa axis represents the width direction X, the ordinate axis represents the height direction Y, and the upper left corner is the origin O(0,0). The position of a person's face region 1002 in the image data 1001 is represented as a region defined by four coordinate points. The result of face detection is expressed as an upper left point LT (Left Top), lower left point LB (Left Bottom), upper right point RT (Right Top), and lower right point (Right Bottom) when facing the person.

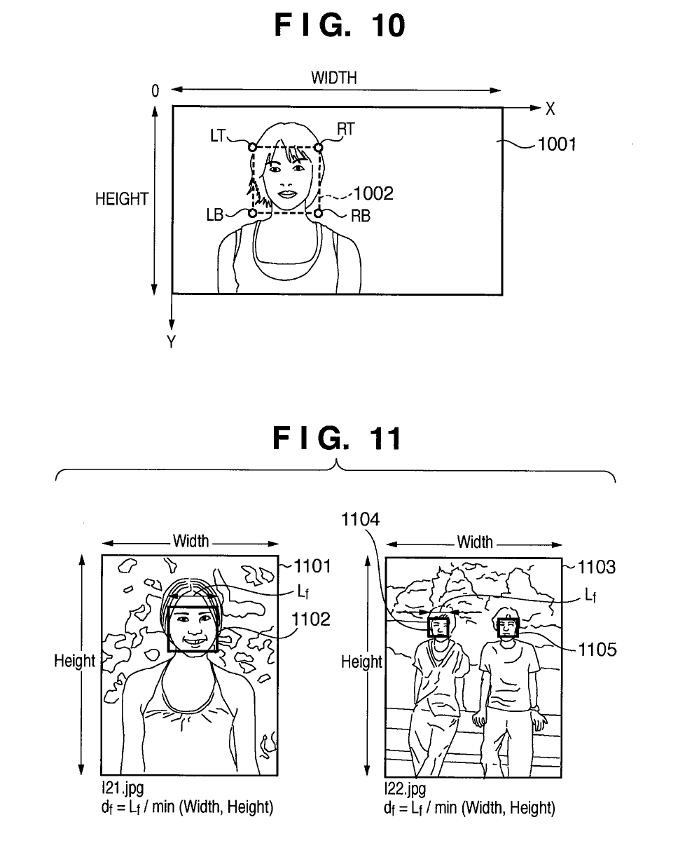

A result of analyzing distance information to a subject (e.g., main subject) based on the face detection result will be explained with reference to FIG. 11.

When a face region 1102 is detected as a result of performing face detection for image data 1101, a face size Lf is given by

L_{f}=|RT−LT|=\sqrt{(x_{RT}−x_{LT})²+(y_{RT}−y_{LT})²} (1)

where LT=(x_{LT},y_{LT}), RT=(x_{RT},y_{RT})

A distance df to a subject is given by

$${d}_{f} = \frac{{L}_{f}}{min ( Width , Height )} \qquad ( 2 )$$

where min(a,b) is a smaller one of a and b.

That is, when the size of image data is represented by the width and height, the ratio of the face size to a smaller one of the width and height is obtained to calculate the distance. A higher ratio of the face size means a nearer view.

Two face detection results are obtained from image data 1103. When a plurality of faces are detected, df (distance) is calculated using a face detection result of the largest Lf (face size). Note that df (distance) may be calculated from the average of all face detection results. The detection result of a face which is small, that is, seems to be in the background and considered to be less relevant may be ignored. A variety of calculation methods are available.

When distance information is obtained using a face detection technique or the like without using Exif information, the above-described process can be executed for even image data which is digital data converted via a scanner from a photograph taken by a silver halide camera.

A case in which a person's face is used as an object has been exemplified. However, the object is not limited to a person's face. The object suffices to be one which can be detected in image data and has a size of a limited range. For example, the object may be a car or flower.

The first embodiment has explained two methods as concrete examples of the image data item analysis process in S203 of FIG. 2. Image data may be analyzed by one or a combination of the two methods. Image data may also be analyzed by another method. The analysis method is arbitrary.

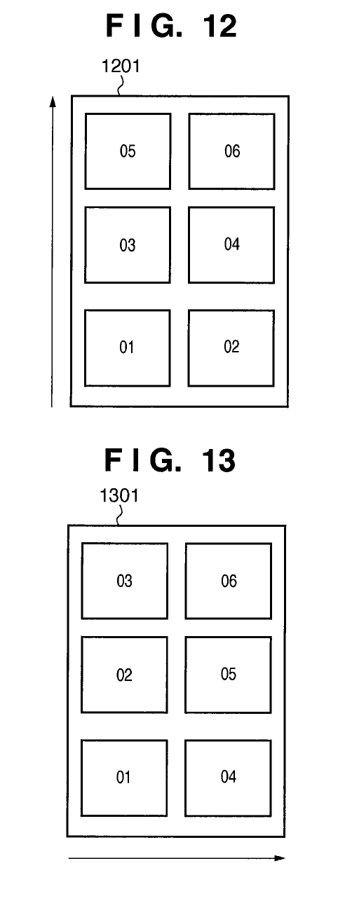

An example of the image layout process in S205 of FIG. 2 will be described with reference to FIGS. 12 to 15. Several layout examples will be described.

In a layout shown in FIG. 12, image data items are laid out in order from a near view to a distance view upward from the bottom of a layout screen (paper surface) 1201. Each numbered rectangular frame is a region to paste an image data item. Photographs with shorter distances to subjects are inserted into rectangular frames of smaller numbers. Photographs with the same distance to subjects may be laid out in ascending order of the capture date (image capture date).

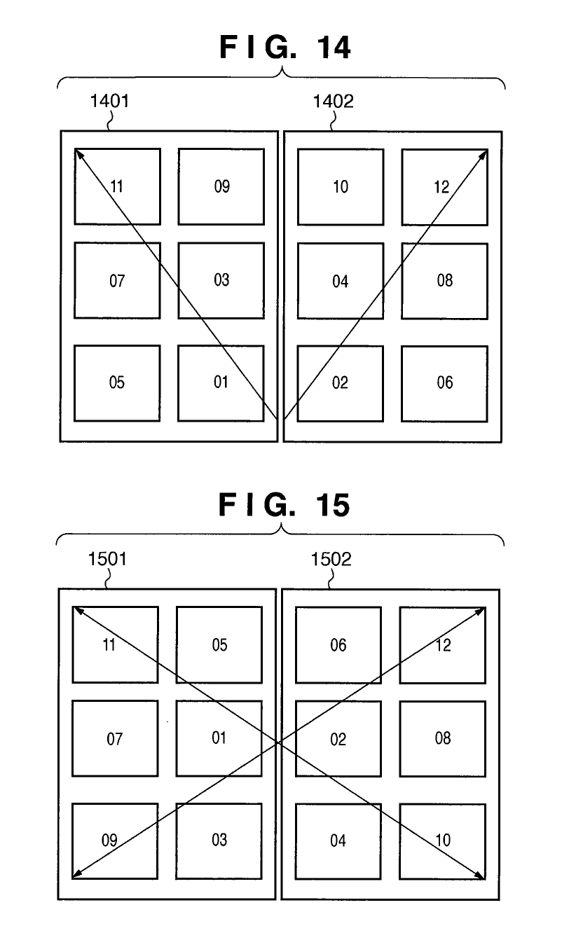

In a layout shown in FIG. 13, image data items are laid out from left to right in order from a near view to a distance view. A layout in FIG. 14 corresponds to a spread page composition. Image data items are laid out in order from a near view to a distance view radially outward from the bottom along the center line of the spread. A layout in FIG. 15 also corresponds to a spread page composition. Image data items are laid out in order from a near view to a distance view radially outward from the center of the spread. In the examples of FIGS. 14 and 15, image data items are laid out radially from the bottom along the center line of the spread or from the center of the spread. However, the position serving as the center (start point) of the image layout can be, for example, the left side with respect to the center line of the spread.

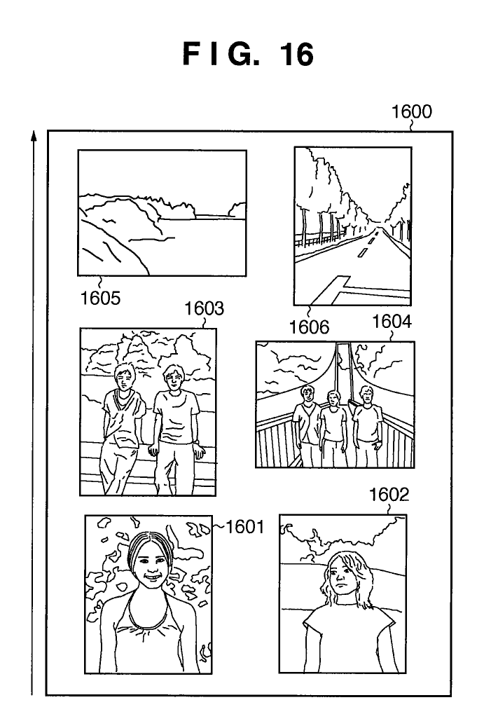

A concrete example of the layout shown in FIG. 12 will be explained with reference to FIG. 16. In this case, six image data items are laid out on a layout screen 1600. The distance to a subject in each image increases in order of image data items 1601, 1602, 1603, 1604, 1605, and 1606.

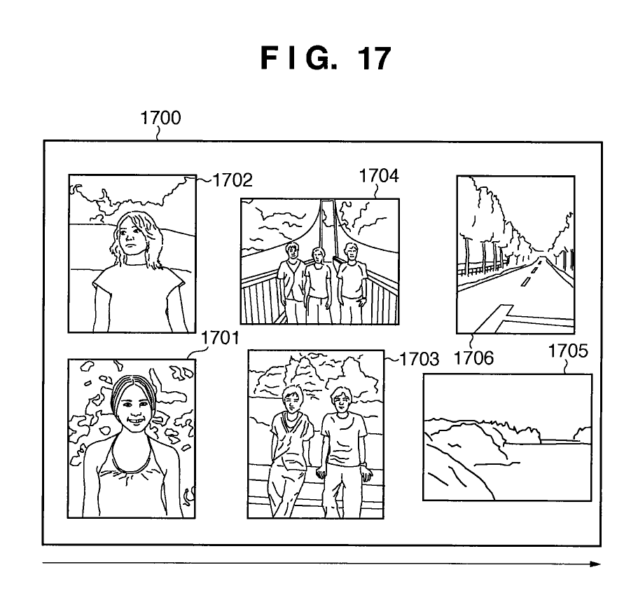

FIG. 17 shows a concrete example of the layout shown in FIG. 13. For a layout in which image data items are laid out side by side, a landscape layout screen is more effective. Six images are laid out on a layout screen 1700. The distance to a subject in each image increases in order of image data items 1701, 1702, 1703, 1704, 1705, and 1706. In the example of FIG. 17, the layout from a near view to a distance view may be mirror-reversed. That is, image data items may be laid out in series from one of the right and left sides of the layout screen to the other side.

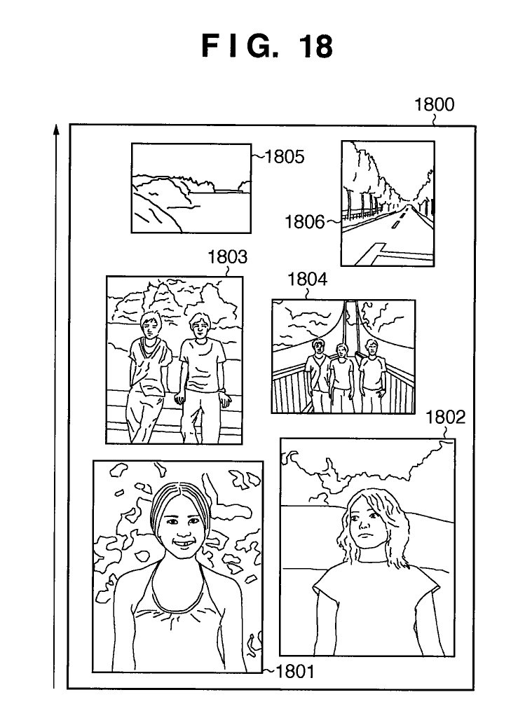

FIG. 18 shows a concrete example of a layout which can emphasize perspective and depth feel. In FIG. 18, image data items 1801 to 1806 are laid out on a layout screen 1800. In FIG. 16, the image data items 1601 to 1606 are laid out with the same size. In FIG. 18, near view images are laid out with large sizes and distance view images are laid out with small sizes, emphasizing perspective and depth feel. As a method of controlling a size Isize of each image, for example, the maximum and minimum values of image regions to be laid out on the layout screen are determined in advance. The size Isize is calculated in accordance with analysis data of the distance to a subject:

$${I}_{size} = ( {I}_{max} - {I}_{min} ) \times \frac{255}{255 - d} + {I}_{min} \qquad ( 3 )$$

where Iₘₐₓ: the maximum value of an image region
Iₘᵢₙ: the minimum value of an image region
d: distance information converted into a value of 0 to 255

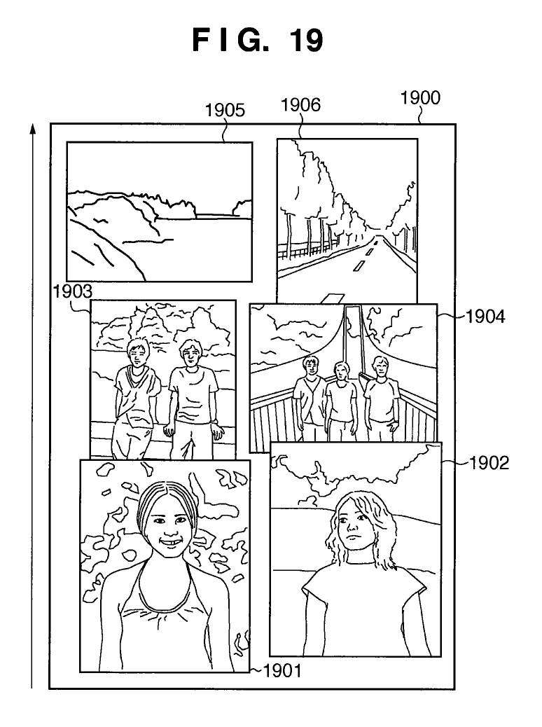

Image data items may also be laid out on the layout screen to overlap each other. FIG. 19 shows a concrete example of this layout. In FIG. 19, six image data items 1901 to 1906 are laid out on a layout screen 1900 to partially overlap each other. The image data items 1901 and 1903 are laid out to partially overlap each other. In this case, distance information to a subject is analyzed for the image data items 1901 and 1903. Then, the image data items 1901 and 1901 are laid out so that image data item with a shorter distance is superposed on the other. As a result, an image with a shorter distance to a subject, that is, a near view image is superposed. The overlapping region may be controlled by changing the composition ratio in accordance with the ratio of distances to main subjects in respective images.

As described above, according to the first embodiment, distance information (using Exif information, face detection technique, or the like) to a subject is analyzed. Based on the analysis result, layout positions are edited to lay out images on the layout screen. Images are laid out in order in accordance with the distance to a subject. The layout screen can provide a pseudo perspective and depth feel.

In the first embodiment, an image selected based on an instruction from the user is a layout target. However, the user need not always select an image to be placed. For example, image data items loaded into the apparatus may be automatically recognized as layout targets and undergo the foregoing processes.

In the first embodiment, a method of laying out images in accordance with a predetermined pattern has been explained with reference to FIGS. 12 to 15. However, the layout method is not limited to this. For example, the user may designate the start point of a near view on the layout screen and a direction in which distance views are arranged.

### Second Embodiment

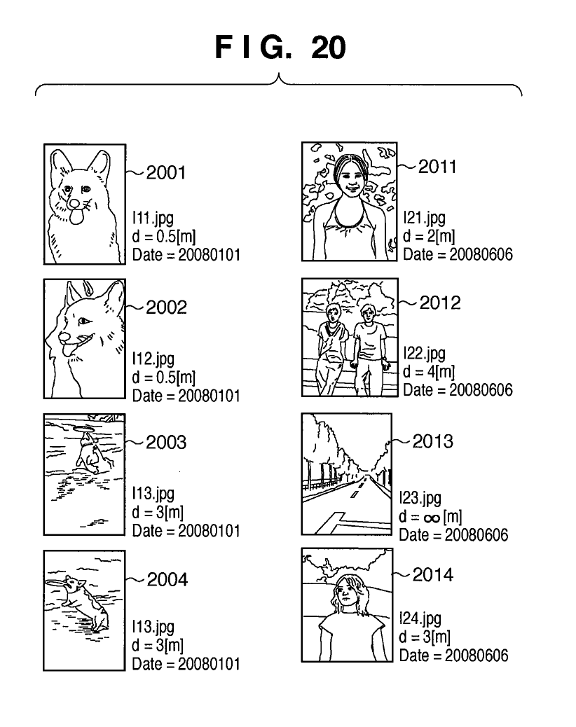

The second embodiment will be described. In the first embodiment, images are laid out based on only distance information to a subject. However, images with different capture dates may coexist in images to be laid out. In an example shown in FIG. 20, the capture date of images 2001 to 2004 is 2008/01/01, and that of images 2011 to 2014 is 2008/06/06. Note that the capture date can be analyzed from Exif information.

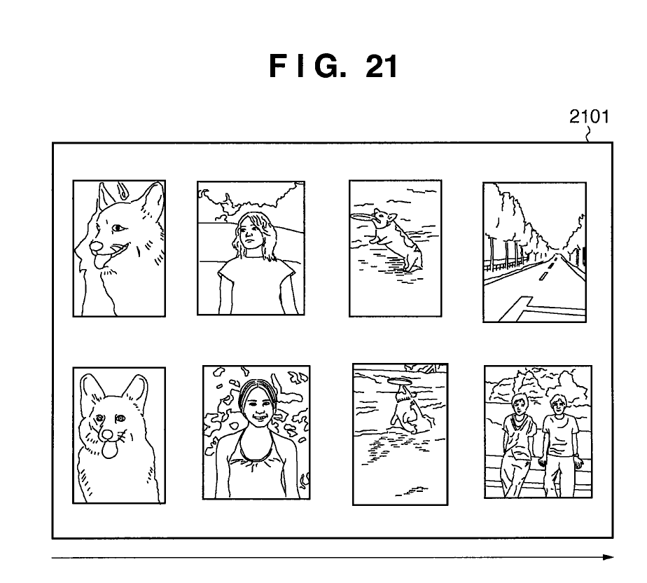

Based on only distance information, images of different capture dates are laid out as shown in FIG. 21. In FIG. 21, images are laid out from left to right based on distance information to a main subject. In this case, images of a person and those of a dog, which are main subjects, are mixed, resulting in a poor-impression layout.

To prevent this, images are grouped by time information, and the layout is controlled among the grouped images. That is, the layout is done in consideration of the capture date in addition to distance information to a subject.

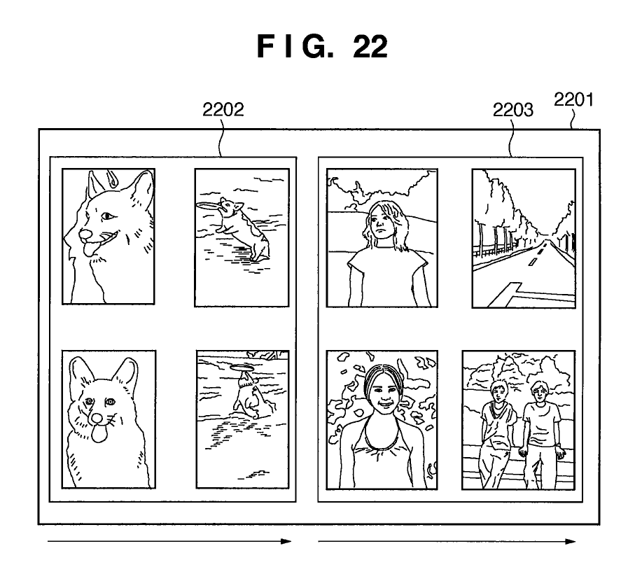

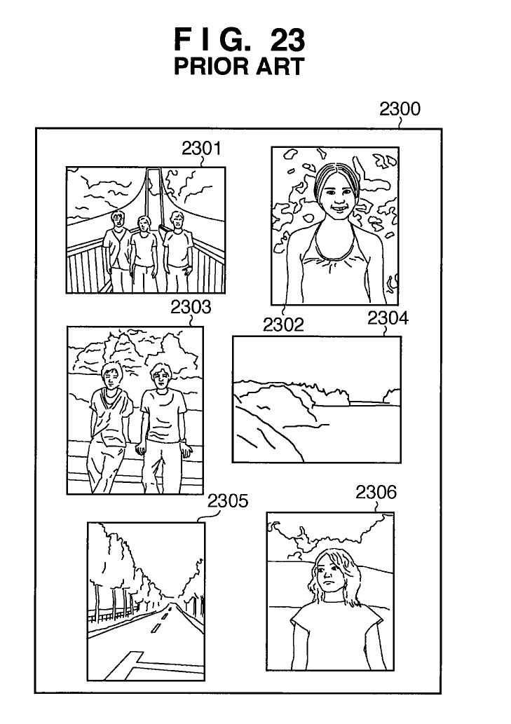

FIG. 22 shows an example of the image layout controlled in this way. In FIG. 22, a layout screen 2201 is divided into two regions by the capture date. Images are laid out in each region. Images captured on 2008/01/01 are laid out in a divided region 2202, and those captured on 2008/06/06 are laid out in a divided region 2203 in consideration of distance information to a main subject.

A more effective layout can be attained by controlling the layout using a combination of distance information to a main subject and other image data information. The combined information is the capture date, captured object, image capture scene, or the like. An object may be detected by a technique such as person detection, personal recognition, or facial expression detection.

Typical embodiments of the present invention have been described above. However, the present invention is not limited to the aforementioned and illustrated embodiments, and can be properly modified without departing from the scope of the invention.

For example, the first and second embodiments have exemplified a case in which an album is created and printed, but the present invention is not limited to this. For example, the present invention is also applicable to layout creation when creating a web page such as a Photo Gallery in which image data items captured by a digital camera are laid out on the web age on the Web (World Wide Web).

According to the present invention, distance information to a subject is analyzed. Based on the analysis result, layout positions are edited to lay out images on the layout screen. The layout screen can provide a pseudo perspective and depth feel.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-246600 filed on Sep. 25, 2008, which is hereby incorporated by reference herein in its entirety.

What is claimed is:

1. An information processing apparatus which edits layout positions of a plurality of images and lays out the plurality of images on a two-dimensional layout screen, the apparatus comprising:
a selection unit configured to select a plurality of images captured by an image capture apparatus as layout targets;
an analysis unit configured to detect either of a subject and a specific portion of the subject as an object in each of the plurality of images selected by the selection unit, and analyze distance information from a position of the image capture apparatus to the object based on a size of the image and a size of the object; and
a layout unit configured to edit the layout positions of the plurality of images based on the distance information obtained by the analysis performed by the analysis unit, and lay out the plurality of images on the layout screen.

2. The apparatus according to claim 1, wherein the layout unit lays out the plurality of images on the layout screen to arrange them in order of the values of the distance information.

3. The apparatus according to claim 1, wherein the layout unit lays out the plurality of images on the layout screen to arrange them in order of the values of the distance information upward from the bottom of the layout screen.

4. The apparatus according to claim 3, wherein the layout unit lays out the plurality of images to arrange them in order of the values of the distance information from one of right and left of the layout screen to the other.

5. The apparatus according to claim 1, wherein the layout unit lays out the plurality of images on the layout screen to arrange them in order of the values of the distance information radially from a predetermined position of the layout screen.

6. The apparatus according to claim 1, wherein the layout unit lays out the plurality of images on the layout screen to arrange them in order of the values of the distance information at positions and a direction which are designated by a user.

7. The apparatus according to claim 2, wherein
each of the plurality of images laid out on the layout screen is placed to partially overlap part of another image, and
when laying out the plurality of images to overlap each other, the layout unit lays out the plurality of images to superpose an image having a small value of the distance information on an image having a large value of the distance information.

8. The apparatus according to claim 2, wherein the layout unit lays out the plurality of images on the layout screen by changing sizes of the plurality of images in accordance with the values of the distance information.

9. The apparatus according to claim 1, wherein
the subject includes a person, and
the specific portion includes a person's face.

10. The apparatus according to claim 1, wherein
each of the plurality of images includes image-capture-related information, and
the analysis unit analyzes the distance information based on an analysis result of the image-capture-related information and an analysis result of the specific portion.

11. The apparatus according to claim 1, wherein
each of the plurality of images includes image-capture-related information,
the analysis unit analyzes information representing an image capture date from the image-capture-related information, and
the layout unit lays out the plurality of images on the layout screen based on the distance information obtained by the analysis performed by the analysis unit and the information representing the image capture date.

12. A processing method for an information processing apparatus which edits layout positions of a plurality of images and lays out the plurality of images on a two-dimensional layout screen, the method comprising:
selecting a plurality of images captured by an image capture apparatus as layout targets;
detecting either of a subject and a specific portion of the subject as an object in each of the plurality of images selected in the selecting the plurality of images to analyze distance information from a position of the image capture apparatus to the object based on a size of the image and a size of the object; and
editing the layout positions of the plurality of images based on the distance information obtained by the analysis in the detecting either of a subject and a specific portion of the subject to lay out the plurality of images on the layout screen.

13. A computer-readable storage medium storing a computer program, the program causing a computer to function as
a selection unit configured to select a plurality of images captured by an image capture apparatus as layout targets,
an analysis unit configured to detect either of a subject and a specific portion of the subject as an object in each of the plurality of images selected by the selection unit, and analyze distance information from a position of the image capture apparatus to the object based on a size of the image and a size of the object, and
a layout unit configured to edit the layout positions of the plurality of images based on the distance information obtained by the analysis performed by the analysis unit, and lay out the plurality of images on a two-dimensional layout screen.
